(19) United States
(12) Patent Application Publication
(10) Pub. No.: US 2026/0369549 A1
(43) Pub. Date: Nov. 19, 2026

(54) NEGATIVE ELECTRODE ACTIVE MATERIAL FOR SECONDARY BATTERY, METHOD FOR MANUFACTURING THE SAME, AND SECONDARY BATTERY USING THE SAME

(71) Applicant: AEKYUNG CHEMICAL CO.,LTD., Seoul (KR)

(72) Inventors: Byungchul JANG, Seoul (KR); Hojun LEE, Daejeon (KR); Hana KWON, Daejeon (KR)

(21) Appl. No.: 19/136,597

(22) PCT Filed: Oct. 4, 2023
(86) PCT No.: PCT/KR2023/015174

§ 371 Date: Jun. 6, 2025

(30) Foreign Application Priority Data
Dec. 8, 2022 (KR) 10-2022-0170566

(51) Int. Cl. H01M 4/04; H01M 4/02; H01M 4/583

(52) U.S. Cl. CPC H01M 4/0471; H01M 4/583; H01M 2004/021; H01M 2004/027

(57) ABSTRACT

The present disclosure relates to a negative electrode active material for a secondary battery, a method for manufacturing same, and a secondary battery using same, the negative electrode active material comprising a carbide carbonized by heat-treating a mixture comprising starch and isocyanate in an inert gas atmosphere. More specifically, the present invention relates to a negative electrode active material for a secondary battery, a method for manufacturing same, and a secondary battery using same, the negative electrode active material having a low specific surface area and improving the initial charging/discharging capacity of a secondary battery.

### CROSS REFERENCE TO RELATED APPLICATIONS

The present application is a U.S. National Phase of International Application No. PCT/KR2023/015174 entitled “NEGATIVE ELECTRODE ACTIVE MATERIAL FOR SECONDARY BATTERY, METHOD FOR MANUFACTURING SAME, AND SECONDARY BATTERY USING SAME,” and filed on Oct. 4, 2023. International Application No. PCT/KR2023/015174 claims priority to Republic of Korea Patent Application No. 10-2022-0170566 filed on Dec. 8, 2022. The entire contents of each of the above-listed applications are hereby incorporated by reference for all purposes.

### TECHNICAL FIELD

The present disclosure relates to a negative electrode active material for a secondary battery including a carbide which is carbonized by heat treating a mixture including starch and an isocyanate under an inert gas atmosphere, a method for manufacturing the same, and a secondary battery using the same. More particularly, the present disclosure relates to a negative electrode active material for a secondary battery having a low specific surface area and an improved initial charge/discharge capacity of a secondary battery, a method for manufacturing the same, and a secondary battery using the same.

### BACKGROUND ART

Recently, as interest and demand for an environmentally friendly green car are increasing, the emergence of cars driven by an electric motor is visualized. The type of cars driven by an electric motor may be electric vehicles (EV), hybrid electric vehicles (HEV), plug-in hybrid electric vehicles (PHEV), and the like, and the power which drives the motor is provided by a secondary battery. A secondary battery for an automobile is required to have very high output characteristics, life characteristics, and the like, unlike batteries applied to mobile IT devices. Among the secondary batteries, a secondary battery has higher energy density relative to weight and excellent output characteristics than a nickel hydrogen battery and is in the spotlight as a power source for the drive motor of an electric vehicle.

Currently, graphite is mostly used as a negative electrode active material of a secondary battery for an automobile, and since graphite shows a high discharge voltage of 3.6 V to allow high energy density of the secondary battery and has excellent reversibility to secure high life characteristics of the secondary battery, it is the most widely used. However, graphite has poor energy input/output characteristics, and in particular, has insufficient low temperature output characteristics. In addition, a volume change of graphite of about 10% occurs during charging/discharging, and thus, a binding force between a current collector and a mixed layer is adversely affected, thereby reducing the life characteristics of a battery.

In order to solve the problems, hardly graphitizable carbon having developed micropores has been suggested and is being used in some cases. The hardly graphitizable carbon has a structure in which lithium ions are stored in numerous pores and released and has almost no volume expansion during charging/discharging of lithium ions so that the life characteristics of a battery are excellent.

In addition, since it may store and release lithium ions through micropores present in all directions of particles, it is known to have excellent output characteristics. However, since the hardly graphitizable carbon has a large specific surface area, the amounts of a solvent and a binder used during manufacture of an electrode slurry should be increased, and the energy density of a battery is decreased as much as the amount of binder increased.

Besides, the hardly graphitizable carbon has an increased moisture adsorption amount in the air due to its high specific surface area, and moisture reacts with an electrolytic solution during the manufacture of a secondary battery to form hydrofluoric acid (HF) to increase an irreversible capacity and reduce durability.

As a method for solving the problems, a method of proceeding with carbonization under normal pressure/pressure in order to decrease a specific surface area by developing closed pores more than open pores or a method of decreasing a specific surface area by forming pyrolytic carbon on the surface of hardly graphitizable carbon has been disclosed. However, recontamination occurs by a tar component and the like during carbonization of a raw material or product uniformity in the upper and lower portions of a raw material crucible is poor.

In Korean Patent Registration No. 10-1375688 (Patent Document 0001), a negative electrode active material including a carbide which was carbonized by heat treating a polyurethane resin under an inert gas atmosphere was manufactured.

A conventional negative electrode active material for a secondary battery as described above had a problem with moisture adsorption due to its relatively high specific surface area.

### RELATED ART DOCUMENT

(Patent Document 0001) Korean Patent Registration No. 10-1375688

### DISCLOSURE

### Technical Problem

The present disclosure is intended to solve the conventional problems and relates to a negative electrode active material for a secondary battery including a carbide which is carbonized by heat treating a mixture including starch and an isocyanate under an inert gas atmosphere.

An object of the present disclosure is to provide a negative electrode active carbonaceous material for a secondary battery which reduces a problem for moisture adsorption due to a small specific surface area, improves battery energy density by improving an initial charge/discharge capacity of a secondary battery, and improves battery characteristics such as charge/discharge output, and a method for manufacturing the same.

A starch is a type of polysaccharide produced by polymerization of glucose, and since it melts during the heat treatment under an inert gas atmosphere to be carbonized, it is difficult to obtain a carbonaceous material having a high amorphous degree. However, an isocyanate is mixed with starch to form a three-dimensional bond, so that a carbonaceous material having a high amorphous degree may be manufactured.

Therefore, an object of the present disclosure is to provide a negative electrode active carbonaceous material for a secondary battery which improves energy density of a secondary battery and improves battery characteristics of high output which is difficult to be expected from a graphite-based negative electrode active material, by manufacturing a hard carbon negative electrode active material as amorphous carbon from a mixture including starch and an isocyanate, and a method for manufacturing the same.

### Technical Solution

According to the present disclosure for achieving the object described above, excellent physical properties of a negative electrode active material may be achieved by carbonization by mixing starch and an isocyanate and then heat treating the mixture under an inert gas atmosphere in order to manufacture a negative electrode active material for a secondary battery.

In one general aspect, a negative electrode active material for a secondary battery includes a carbide which is carbonized by heat treating a mixture including starch and an isocyanate under an inert gas atmosphere.

In an exemplary embodiment, the mixture may further include a phosphorus-based flame retardant.

In an exemplary embodiment, the starch may be at least one selected from the group consisting of corn starch, rice starch, barley starch, wheat starch, cassava starch, potato starch, and sweet potato starch, and it is preferred to use corn starch, but is not limited thereto.

In an exemplary embodiment, the starch may have an average diameter (D50) of 1 to 20 μm, preferably 5 to 10 μm, but is not limited thereto.

In an exemplary embodiment, the starch may have a spherical particle form.

In an exemplary embodiment, the negative electrode active material for a secondary battery may have an amorphous particle form after the heat treatment.

In addition, in an exemplary embodiment, the isocyanate may be at least one selected from the group consisting of hexamethylene diisocyanate (HDI), isophorone diisocyanate (IPDI), 4,4′-dicyclohexylmethane diisocyanate (H12MDI), polyethylene polyphenyl isocyanate, toluene diisocyanate (TDI), 2,2′-diphenylmethane diisocyanate (2,2′-MDI), 2,4′-diphenylmethane diisocyanate (2,4′-MDI), 4,4′-diphenylmethane diisocyanate (4,4′-MDI, monomeric MDI), polymeric diphenylmethane diisocyanate (polymeric MDI), orthotoluidine diisocyanate (TODI), naphthalene diisocyanate (NDI), xylene diisocyanate (XDI), lysin diisocyanate (LDI), and triphenylmethane triisocyanate (TPTI), but is not limited thereto.

In an exemplary embodiment, the isocyanate may be preferably at least one selected from the group consisting of 4,4′-diphenylmethane diisocyanate (4,4′-MDI, monomeric MDI), polymeric diphenylmethane diisocyanate (polymeric MDI), and polyethylene polyphenyl isocyanate, but is not limited thereto.

In an exemplary embodiment, the heat treatment may include a precarbonization step of performing a first heat treatment and a carbonization step of performing a second heat treatment.

In an exemplary embodiment, the precarbonization step of performing the first heat treatment may be performed at a temperature of 600 to 1400 °C, specifically 600 to 1000 °C, but is not limited thereto.

In an exemplary embodiment, the precarbonization step of performing the first heat treatment may be performed for 30 minutes to 360 minutes, preferably 30 to 120 minutes, but is not limited thereto.

In an exemplary embodiment, the carbonization step of performing the second heat treatment may be performed at 1000 to 1400 °C, preferably 1100 to 1400 °C, and more preferably 1100 to 1200 °C, but is not limited thereto.

In an exemplary embodiment, the carbonization step of performing the second heat treatment may be performed for 30 minutes to 360 minutes, preferably 30 to 120 minutes, but is not limited thereto.

In an exemplary embodiment, the precarbonization step of performing the first heat treatment and the carbonization step of performing the second heat treatment may be performed sequentially.

In an exemplary embodiment, the isocyanate may be included at 15 to 40 parts by weight with respect to 100 parts by weight of the mixture including the starch and the isocyanate.

In an exemplary embodiment, the mixture may further include a phosphorus-based flame retardant.

In an exemplary embodiment, the phosphorus-based flame retardant may be selected from tris(2-chloropropyl) phosphate (TCPP), tris(2-chroroethyl) phosphate (TCEP), triethyl phosphate (TEP), or trimethyl phosphate (TMP), and is preferably tris(2-chloropropyl) phosphate (TCPP), but is not limited thereto.

In an exemplary embodiment, the mixture including the starch and the isocyanate may further include a catalyst.

In another general aspect, a method for manufacturing a negative electrode active material for a secondary battery is provided.

In an exemplary embodiment, the method for manufacturing a negative electrode active material for a secondary battery includes: a carbonization step of mixing starch and an isocyanate to prepare a precursor and heat treating the prepared precursor under an inert gas atmosphere.

In an exemplary embodiment, the starch and the isocyanate may be uniformly mixed at a specific ratio to obtain a precursor. The mixing method may be preferably mixing by an impeller, but is not limited thereto.

In an exemplary embodiment, a carbonization step of heat treating the starch and the isocyanate under an inert gas atmosphere may be performed.

In an exemplary embodiment, a carbonization step of mixing the starch and the isocyanate at 20 to 60 °C for 50 to 60 minutes and then heat treating the mixture under an inert gas atmosphere may be performed.

In an exemplary embodiment, the carbonization step may include a precarbonization step and a carbonization step.

In an exemplary embodiment, the precarbonization step may be performed at a temperature of 600 to 1400 °C, preferably 600 to 1000 °C, and more preferably 600 to 800 °C, but is not limited thereto.

In an exemplary embodiment, the precarbonization step may be performed for 30 minutes to 360 minutes, preferably 30 to 120 minutes, but is not limited thereto.

In an exemplary embodiment, the carbonization step may be performed at a temperature of 1000 to 1400 °C, preferably 1100 to 1400 °C, and more preferably 1100 to 1200 °C, but is not limited thereto.

In an exemplary embodiment, the carbonization step may be performed for 30 minutes to 360 minutes, preferably 30 to 120 minutes, but is not limited thereto.

In an exemplary embodiment, the precarbonization step and the carbonization step may be performed sequentially.

In an exemplary embodiment, the precarbonization step may be performed under an inert gas atmosphere, and the inert gas may be preferably helium, nitrogen, argon, or a mixed gas thereof, but is not limited thereto.

In an exemplary embodiment, the method for manufacturing a negative electrode active material for a secondary battery may include a fine grinding step of adjusting a particle size into a size appropriate for manufacturing an electrode for a secondary battery, before the precarbonization step, after the precarbonization step, or after the carbonization step.

In an exemplary embodiment, the fine grinding step may be performed using a common grinder using a mechanical grinding method, in particular, using various grinding devices such as a ball mill, a pin mill, a rotor mill, or a jet mill, but is not limited thereto. In an exemplary embodiment, when the fine grinding step is performed after the precarbonization step, it is preferred to use a jet mill, but the present disclosure is not limited thereto.

In an exemplary embodiment, the ground particles of the negative electrode active material may have an average diameter (D50) of 1 to 50 μm, preferably 3 to 50 μm, specifically 3 to 20 μm, and most specifically 6 to 15 μm, but is not limited thereto.

In an exemplary embodiment, the method for manufacturing a negative electrode active material for a secondary battery may include a carbonization step of performing a heat treatment at a temperature of 1000 to 1400 °C for 30 minutes to 120 minutes after performing the precarbonization step and the fine grinding step.

In an exemplary embodiment, the carbonization step may be a step for optimizing characteristics as a negative electrode material for a secondary battery, by improving conductivity of carbon after removing low-molecular weight gases produced in the precarbonization step.

In an exemplary embodiment, the carbonization step is performed under an inert gas atmosphere, and the inert gas may be helium, nitrogen, argon, or a mixed gas thereof, but is not limited thereto.

In an exemplary embodiment, a heat treatment temperature of the carbonization step may be 1000 to 1400 °C, preferably 1100 to 1400 °C, and more preferably 1100 to 1200 °C, but is not limited thereto.

In an exemplary embodiment, the negative electrode active material may have a specific surface area of 1.9 to 2.7 m²/g.

In an exemplary embodiment, the negative electrode active material may have an average pore size of 1.0 to 20 nm, preferably 1.0 to 5 nm, as shown in FIG. 5, but is not limited thereto.

In addition, in an exemplary embodiment, the negative electrode active material may have an average layer plane spacing (d002) of a (002) plane by X-ray diffraction (XRD) analysis of 3.4 to 4.3 Å, preferably 3.7 to 4.0 Å, but is not limited thereto.

In an exemplary embodiment, the negative electrode active material may have a crystallite diameter Lc(002) in the C-axis direction of 0.8 to 2.0 nm, preferably 0.9 to 1.0 nm, but is not limited thereto.

In an exemplary embodiment, the negative electrode active material may have an R value of 1.3 to 2, preferably 1.7 to 2, but is not limited thereto.

In an exemplary embodiment, the negative electrode active material may have a charge capacity per unit weight of 370 to 500 (mAh/g), preferably 390 to 480 (mAh/g), and more preferably 400 to 420 (mAh/g), but is not limited thereto.

In an exemplary embodiment, the negative electrode active material may have a discharge capacity per unit weight of 270 to 380 (mAh/g), preferably 290 to 350 (mAh/g), and more preferably 320 to 350 (mAh/g), but is not limited thereto.

In an exemplary embodiment, the negative electrode active material may have an average layer plane spacing (d002) of a (002) plane by X-ray diffraction analysis of 3.7 to 4.0 Å, a crystallite diameter Lc(002) in the C-axis direction of 0.9 to 1.0 nm, and an R value of 1.7 to 2.

The negative electrode active material for a secondary battery manufactured by the manufacturing method of the present disclosure is formed into a structure which has a low moisture adsorption rate and is easy to be charged/discharged and may improve the initial charge/discharge efficiency of a secondary battery, by having physical properties in the above range. In addition, it was confirmed that the structure of the negative electrode active material for a secondary battery is formed by a microstructure close to amorphous which includes fine and uniform pores by a binding reaction of starch and an isocyanate.

In still another general aspect, a secondary battery includes the negative electrode active material for a secondary battery.

### Advantageous Effects

According to the negative electrode active carbonaceous material for a secondary battery and the method for manufacturing the same, the specific surface area of the negative electrode active material is low, and a charge/discharge capacity is higher than a polyurethane resin which has been conventionally widely used, by manufacturing a negative electrode active material including a carbide which is carbonized by heat treating a precursor formed by mixing starch and an isocyanate under an inert gas atmosphere.

In addition, a secondary battery including the negative electrode active material may improve initial discharge capacity, efficiency, and output of a battery.

### DESCRIPTION OF DRAWINGS

FIG. 1 is a scanning electron microscope photograph showing corn starch used as a negative electrode active material of a secondary battery according to the present disclosure.

FIG. 2 is a scanning electron microscope photograph of the negative electrode active material of the secondary battery according to the present disclosure.

FIG. 3 is a photograph of a scanning electron microscope of the negative electrode active material manufactured using a polyurethane resin prepared by Comparative Example 1 of the negative electrode active material of the secondary battery according to the present disclosure.

FIG. 4 is a graph in which mesopores on surfaces of the negative electrode active material manufactured according to Example 1 of the present disclosure and the negative electrode active material manufactured according to Comparative Example 1 were analyzed.

FIG. 5 is a graph in which micropores on the surface of the negative electrode active material of the secondary battery according to the present disclosure were analyzed.

FIG. 6 is an initial charge/discharge graph of the negative electrode active material of the secondary battery according to the present disclosure.

FIG. 7 is a graph of evaluating room temperature discharge output characteristics of the negative electrode active material manufactured according to Example 1 of the present disclosure and the negative electrode active material manufactured according to Comparative Example 1.

### BEST MODE

According to the present disclosure for achieving the object described above, excellent physical properties of a negative electrode active material so that a post-treatment such as additional carbon coating is not needed may be achieved, by carbonizing by mixing starch and an isocyanate and then heat treating the mixture under an inert gas atmosphere in order to manufacture a negative electrode active material for a secondary battery.

In an exemplary embodiment, the mixture may further include a phosphorus-based flame retardant.

In an exemplary embodiment, the starch may be at least one selected from the group consisting of corn starch, rice starch, barley starch, wheat starch, cassava starch, potato starch, and sweet potato starch, and it is preferred to use corn starch, but the present disclosure is not limited thereto.

In an exemplary embodiment, the starch may have an average diameter (D50) of 1 to 20 μm, preferably 5 to 10 μm, but is not limited thereto.

In an exemplary embodiment, the starch may have a spherical particle form.

In an exemplary embodiment, the negative electrode active material for a secondary battery may have an amorphous particle form after the heat treatment.

In an exemplary embodiment, the isocyanate may be at least one selected from the group consisting of hexamethylene diisocyanate (HDI), isophorone diisocyanate (IPDI), 4,4′-dicyclohexylmethane diisocyanate (H12MDI), polyethylene polyphenyl isocyanate, toluene diisocyanate (TDI), 2,2′-diphenylmethane diisocyanate (2,2′-MDI), 2,4′-diphenylmethane diisocyanate (2,4′-MDI), 4,4′-diphenylmethane diisocyanate (4,4′-MDI, monomeric MDI), polymeric diphenylmethane diisocyanate (polymeric MDI), orthotoluidine diisocyanate (TODI), naphthalene diisocyanate (NDI), xylene diisocyanate (XDI), lysin diisocyanate (LDI), and triphenylmethane triisocyanate (TPTI), but is not limited thereto.

In an exemplary embodiment, the isocyanate may be preferably at least one selected from the group consisting of 4,4′-diphenylmethane diisocyanate (4,4′-MDI, monomeric MDI), polymeric diphenylmethane diisocyanate (polymeric MDI), and polyethylene polyphenyl isocyanate, but is not limited thereto.

In an exemplary embodiment, the heat treatment may include a precarbonization step of performing a first heat treatment and a carbonization step of performing a second heat treatment.

In an exemplary embodiment, the precarbonization step of performing the first heat treatment may be performed at a temperature of 600 to 1400 °C, specifically 600 to 1000 °C, but is not limited thereto.

In an exemplary embodiment, the precarbonization step of performing the first heat treatment may be performed for 30 minutes to 360 minutes, preferably 30 to 120 minutes, but is not limited thereto.

In an exemplary embodiment, the carbonization step of performing the second heat treatment may be performed at 1000 to 1400 °C, preferably 1100 to 1400 °C, and more preferably 1100 to 1200 °C, but is not limited thereto.

In an exemplary embodiment, the carbonization step of performing the second heat treatment may be performed for 30 minutes to 360 minutes, preferably 30 to 120 minutes, but is not limited thereto.

In an exemplary embodiment, the precarbonization step of performing the first heat treatment and the carbonization step of performing the second heat treatment may be performed sequentially.

In an exemplary embodiment, the isocyanate may be included at 10 parts by weight or more, 15 parts by weight or more, 20 parts by weight or more, 25 parts by weight or more, or 30 parts by weight or more, with respect to 100 parts by weight of the mixture including the starch and the isocyanate. In addition, the isocyanate may be included at 50 parts by weight or less, 45 parts by weight or less, 40 parts by weight or less, 35 parts by weight or less, or 30 parts by weight or less, with respect to 100 parts by weight of the mixture including the starch and the isocyanate. Specifically, the isocyanate may be included at 15 to 40 parts by weight, and the isocyanate may be included at 25 to 35 parts by weight, with respect to 100 parts by weight of the mixture including the starch and the isocyanate.

In an exemplary embodiment, when the content of the isocyanate is 15 to 40 parts by weight with respect to 100 parts by weight of the mixture including the starch and the isocyanate, sufficient binding with starch is formed, and electrical properties are excellent when the mixture is manufactured into a secondary battery.

In an exemplary embodiment, the mixture may further include a phosphorus-based flame retardant.

In addition, in an exemplary embodiment, the phosphorus-based flame retardant may be selected from tris(2-chloropropyl) phosphate (TCPP), tris(2-chroroethyl) phosphate (TCEP), triethyl phosphate (TEP), or trimethyl phosphate (TMP), and is preferably tris(2-chloropropyl) phosphate (TCPP), but is not limited thereto.

In an exemplary embodiment, the phosphorus-based flame retardant may be included at 0 parts by weight or more, 1 part by weight or more, 2 parts by weight or more, 3 parts by weight or more, 4 parts by weight or more, or 5 parts by weight or more, with respect to 100 parts by weight of the mixture. In addition, the phosphorus-based flame retardant may be included at 10 parts by weight or less, 9 parts by weight or less, 8 parts by weight or less, 7 parts by weight or less, 6 parts by weight or less, or 5 parts by weight or less, with respect to 100 parts by weight of the mixture.

In an exemplary embodiment, the mixture including the starch and the isocyanate may further include a catalyst.

Next, the method for manufacturing a negative electrode active material for a secondary battery will be described in detail. In an exemplary embodiment, the method for manufacturing a negative electrode active material for a secondary battery includes: a carbonization step of mixing the starch and the isocyanate described above to prepare a precursor and heat treating the prepared precursor under an inert gas atmosphere.

In an exemplary embodiment, the starch and the isocyanate may be uniformly mixed at a specific ratio to obtain a precursor. The mixing method may be preferably mixing by an impeller, but is not limited thereto.

In an exemplary embodiment, a carbonization step of heat treating the starch and the isocyanate under an inert gas atmosphere may be performed.

In an exemplary embodiment, a carbonization step of mixing the starch and the isocyanate at 20 to 60 °C for 50 to 60 minutes and then heat treating the mixture under an inert gas atmosphere may be performed.

In an exemplary embodiment, the carbonization step may include a precarbonization step and a carbonization step.

In an exemplary embodiment, the precarbonization step may be performed at a temperature of 600 to 1400 °C, preferably 600 to 1000 °C, and more preferably 600 to 800 °C, but is not limited thereto.

In an exemplary embodiment, the precarbonization step may be performed for 30 minutes to 360 minutes, preferably 30 to 120 minutes, but is not limited thereto.

In an exemplary embodiment, the carbonization step may be performed at a temperature of 1000 to 1400 °C, preferably 1100 to 1400 °C, and more preferably 1100 to 1200 °C, but is not limited thereto.

In an exemplary embodiment, the carbonization step may be performed for 30 minutes to 360 minutes, preferably 30 to 120 minutes, but is not limited thereto.

In an exemplary embodiment, the precarbonization step and the carbonization step may be performed sequentially, but are not limited thereto.

In an exemplary embodiment, the precarbonization step may be performed under an inert gas atmosphere, and the inert gas may be preferably helium, nitrogen, argon, or a mixed gas thereof, but is not limited thereto.

When the precarbonization step is performed at 600 °C or higher, a problem of contaminating the inside of an electric furnace and the surface of a product by residual gas occurring in the carbonization step may be solved.

In addition, when the precarbonization step is performed at 1000 °C or lower, increased manufacturing costs due to excessive supply of heat quantity may be prevented.

In an exemplary embodiment, the method for manufacturing a negative electrode active material for a secondary battery may include a fine grinding step of adjusting a particle size into a size appropriate for manufacturing an electrode for a secondary battery, before the precarbonization step, after the precarbonization step, or after the carbonization step, but is not limited thereto.

In an exemplary embodiment, the fine grinding step may be performed using a common grinder using a mechanical grinding method, in particular, using various grinding devices such as a ball mill, a pin mill, a rotor mill, or a jet mill, but is not limited thereto.

In general, when a jet mill grinding process which is easy for fine grinding is performed after the precarbonization step, a problem in which it is difficult to reduce a particle size to 60 μm or less due to the limit to increase an impact amount between particles with the low specific gravity of a polyurethane resin may be solved.

In addition, when pin mill and rotor mill processes are performed after the precarbonization step, a problem in which it is difficult to reduce a particle size due to a limit to a rotational force and the low specific gravity of particles may be solved.

Therefore, when the fine grinding step is performed using a jet mill, a pin mill, or a rotor mill, it is preferred to perform it after the precarbonization step or the carbonization step, but the present disclosure is not limited thereto.

In an exemplary embodiment, the fine grinding step is performed after the precarbonization step, it is preferred to use a jet mill, but the present disclosure is not limited thereto.

In an exemplary embodiment, the ground particles of the negative electrode active material may have an average diameter (D50) of 1 to 50 μm, preferably 3 to 50 μm, specifically 3 to 20 μm, and most specifically 6 to 15 μm, but is not limited thereto.

When the average diameter (D50) is 3 μm or more, a fine powder generation amount of less than 1 μm is increased, the specific surface area of particles is increased, and the characteristics of adsorbing moisture in the air is increased, thereby causing a side reaction by moisture in a battery reaction to solve a problem of increasing an irreversible capacity.

In addition, when the average diameter (D50) is 3 μm or more, fine particles are increased, a porosity between particles is increased, a packing density of particles is decreased, and a problem of deteriorating a high temperature storage characteristic such as easily eluting ions inserted inside carbon particles at a high temperature of 65 °C or higher during a battery reaction may be solved.

In addition, when the average diameter (D50) is 50 μm or less, an interface of particles is decreased to decrease the area for ion entry/exit, and a problem of deteriorating ion entry/exit characteristics during a battery reaction may be solved.

In an exemplary embodiment, a carbonization step of heat treating at a temperature of 1000 to 1400 °C for 30 to 120 minutes is included after performing the precarbonization step and the fine grinding step, but the present disclosure is not limited thereto.

The carbonization step may be a step for optimizing characteristics as a negative electrode material for a secondary battery, by improving conductivity of carbon after removing low-molecular weight gases produced in the precarbonization step.

The carbonization step is performed under an inert gas atmosphere, and the inert gas may be helium, nitrogen, argon, or a mixed gas thereof, but is not limited thereto.

In an exemplary embodiment, a heat treatment temperature of the carbonization step may be 1000 to 1400 °C, preferably 1100 to 1400 °C, and more preferably 1100 to 1200 °C, but is not limited thereto.

When the carbonization is performed at a temperature of 1000 °C or higher, hydrogen remaining in carbon irreversibly reacts to solve a problem of causing a battery capacity reduction in the first 5 cycles or so may be solved.

When the carbonization is performed at a temperature of higher than 1400 °C, a reversible capacity which is a storage ability of ions is decreased to greatly decrease energy density during battery manufacture, and when carbonization is performed at a temperature of lower than 1000 °C, the specific surface area is increased to increase the characteristics of adsorbing moisture in the air, so that moisture reacts in the battery reaction to cause a problem of increasing an irreversible capacity.

In addition, commercially, in order for an electric furnace to withstand a heat treatment temperature of higher than 1400 °C, the material and composition of the electric furnace should be changed to those resistant to heat, and thus, when carbonization is performed at a temperature of 1400 °C or lower, a problem of increasing manufacturing costs and process costs may be solved.

In an exemplary embodiment, the negative electrode active material may have a specific surface area of 1.0 m²/g or more, 1.5 m²/g or more, 1.9 m²/g or more, 2.0 m²/g or more, 2.1 m²/g or more, 2.2 m²/g or more, 2.3 m²/g or more, or 2.4 m²/g or more. In addition, the negative electrode active material may have a specific surface area of 10.0 m²/g or less, 5.0 m²/g or less, 3.5 m²/g or less, 3.2 m²/g or less, 2.9 m²/g or less, 2.8 m²/g or less, 2.7 m²/g or less, or 2.6 m²/g or less. The negative electrode active material may have a specific surface area of 1.0 to 10.0 m²/g, specifically 1.5 to 5.0 m²/g, and more specifically 1.9 to 2.7 m²/g, but is not limited thereto.

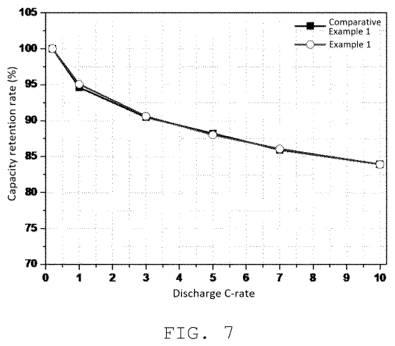

In an exemplary embodiment, the negative electrode active material may have an average pore size of 1.0 to 20 nm, preferably 1.0 to 5 nm, as shown in FIG. 5, but is not limited thereto.

In addition, in an exemplary embodiment, the negative electrode active material may have an average layer plane spacing (d002) of a (002) plane by X-ray diffraction (XRD) analysis of 3.4 to 4.3 Å, preferably 3.7 to 4.0 Å, but is not limited thereto.

In an exemplary embodiment, the negative electrode active material may have a crystallite diameter Lc(002) in the C-axis direction of 0.8 to 2.0 nm, preferably 0.9 to 1.0 nm, but is not limited thereto.

In an exemplary embodiment, the negative electrode active material may have an R value of 1.3 to 2, preferably 1.7 to 2, but is not limited thereto.

In an exemplary embodiment, the negative electrode active material may have a charge capacity per unit weight of 370 to 500 (mAh/g), preferably 390 to 480 (mAh/g), and more preferably 400 to 420 (mAh/g), but is not limited thereto.

In an exemplary embodiment, the negative electrode active material may have a discharge capacity per unit weight of 270 to 380 (mAh/g), preferably 290 to 350 (mAh/g), and more preferably 320 to 350 (mAh/g), but is not limited thereto.

In an exemplary embodiment, the negative electrode active material may have an average layer plane spacing (d002) of a (002) plane by X-ray diffraction analysis of 3.7 to 4.0 Å, a crystallite diameter Lc(002) in the C-axis direction of 0.9 to 1.0 nm, and an R value of 1.7 to 2.

The negative electrode active material for a secondary battery manufactured by the manufacturing method of the present disclosure is formed into a structure which has a low moisture adsorption rate and is easy to be charged/discharged to improve the initial charge/discharge efficiency of a secondary battery, by having physical properties in the above range. In addition, it was confirmed that the structure of the negative electrode active material for a secondary battery is formed by a microstructure close to amorphous which includes fine and uniform pores by a binding reaction of starch and an isocyanate.

In still another general aspect, a secondary battery includes the negative electrode active material for a secondary battery.

Hereinafter, preferred exemplary embodiments and evaluation test items for the negative electrode active carbonaceous material for a secondary battery of the present disclosure and the method for manufacturing the same will be described in detail. The present disclosure will be understood better by the following examples, and the following examples are intended to be illustrative of the present disclosure and not to limit the protection scope, defined by the attached claims.

### <Evaluation Test Items>

### 1) XRD Measurement

\textcircled{1} Analysis of Average Layer Plane Spacing (d002) of Particles

A graph of a 2θ value measured by X-ray diffraction analysis was obtained, a peak position of the graph was determined by a integration method, and d002 (d002=λ/2 sin θ) was calculated by a Bragg's formula. The wavelength of a CuKα ray was set to 0.15406 nm. At this time, a measurement range was 5° to 80°, and a measurement speed was set to 5°/min.

### \textcircled{2} Comparison Analysis of Graphite Lattice Crystallinity (R Value)

An R value is defined as each intensity ratio of (A) and (B) at 2θ showing a (002) peak.

(A) is a background established by drawing a straight line based on a baseline on both sides of the (002) peak, and (B) is an intensity at a contact point where the background moves in parallel toward the (002) peak to meet the (002) peak.

### \textcircled{3} Analysis of Crystalline Size of Particles

A crystallite thickness Lc(002) in the direction of the C-axis was calculated by a Scherrer equation.

Lc(002)=Kλ/(B cos θ)
K=0.9
2=wavelength (0.154056 nm)
B=FWHM (Full Width at Half Maximum)

### 2) Measurement of Specific Surface Area

A sample was collected and degassed at 300 °C for 3 hours through a pretreatment device, and the specific surface area of the sample was measured in a pressure range (P/P0) by a nitrogen gas adsorption BET method of 0.05 to 0.3 through a Surface Area, Pore Size Analyzer device.

### 3) Analysis of Surface Pores

A degassing treatment was performed at 300 °C for 3 hours through a pretreatment device, and the pores on the surface of the sample were analyzed by a nitrogen gas adsorption method through a Pore Size Analyzer (Micromeritics ASAP2020).

The analysis showed a total volume distribution of pores having a diameter of 2 nm or less (micropores) and showed a total volume distribution of pores having a diameter of 2 to 50 nm (mesopores) by a BJH method.
Micropores=≤2 nm
Mesopores=2-50 nm
Macropores=≥50 nm

### 4) Method for Manufacturing Measurement Cell

A measurement cell used an electrode manufactured from a negative electrode active material and a binder at a ratio of 97:3 as a coin type half battery and a lithium metal foil as a counter electrode, EC/EMC/DMC as an organic electrolytic solution was mixed at a ratio of 1:1:1 with a separator therebetween, and an electrolytic solution in which 1 M LiPF₆ was dissolved was impregnated thereto, thereby manufacturing a 2016 type coin cell.

### 5) Evaluation of Charge/Discharge Characteristics

For charging, lithium ions were inserted into a carbon electrode to 0.005 V at 0.1 C rate by a constant current method, lithium ion insertion was performed from 0.005 V by the constant current method, and when the current was 0.01 C, lithium ion insertion was ended. For discharging, lithium ions were desorbed from the carbon electrode with a termination voltage of 1.5 V by a constant current method at 0.1 C rate, and a total of 5 charges and discharges were performed.

### 6) Evaluation of Output Characteristics

Evaluation of output characteristics was measuring output characteristics during lithium ion discharging, and 5 cycles of charge/discharge were performed initially at 0.1 C, only discharge (lithium ion desorption) C rate was increased stepwisely, and a retention rate of a 10 C-rate reversible capacity as compared with a 0.2 C rate reversible capacity was measured.

### Manufacture of Secondary Battery

### (a) Manufacture of Electrode

2 parts by weight of styrene butadiene rubber, 1 part by weight of carboxymethyl cellulose (CMC), and distilled water were added to 97 parts by weight of the negative electrode active material manufactured above, the mixture was uniformly stirred into a slurry form, and the slurry was uniformly coated on a copper foil. Coating was performed uniformly at 80 μm using a doctor blade and dried in an oven at 80 °C for 10 minutes, and pressing was performed at a pressure of 0.6 MPa. An electrode on the foil was punched in a circular shape having an area of 1.5 cm², and dried in a vacuum oven at 120 °C for 5 hours.

### (b) Manufacture of Test Battery

The negative electrode active material manufactured in the above example was used in a negative electrode of a water-based electrolyte secondary battery.

A lithium secondary battery was assembled in a glove box under an argon atmosphere with a coin type battery of 2016 size (diameter of 20 mm, thickness of 16 mm), and metal lithium having a thickness of 1 mm was pressed into the bottom of a coin type battery can, a separator made of polypropylene was formed thereon, and the negative electrode was placed facing lithium. At this time, the used electrolyte was prepared by adding a 1M LiPF₆ salt to a solvent prepared by mixing ethylene carbonate (EC), dimethyl carbonate (DMC), and ethyl methyl carbonate (EMC) at a volume ratio of 1:1:1, and it was added to a coin type battery, a can cover was closed, and pressing was performed to assemble a lithium secondary battery.

### (c) Measurement of Battery Capacity

Analysis of the characteristics of the assembled lithium secondary battery was performed by performing charge/discharge at 25 °C by a constant current-constant voltage (CCCV) method using a HC0105R charge/discharge test device manufactured by HNT SYSTEM. The constant current-constant voltage conditions were performing charge at a constant current density (based on 0.1 C) until the voltage of the coin type battery was 0.005 V, and then charge was performed by decreasing the current steadily until the current value was 0.01 C while the voltage was maintained, thereby measuring a charge capacity. After finishing the charge, the operation of the battery was stopped for 10 minutes, and discharge was performed. The discharge was performed at a constant current until the voltage of the coin type battery was 1.5 V, thereby measuring a discharge capacity. A reversible capacity was defined as a discharge capacity, an irreversible capacity was calculated as a capacity obtained by subtracting the discharge capacity from the charge capacity, and efficiency was a discharge capacity compared with a charge capacity calculated as a percent (%). The characteristic values of the basic coin type battery were represented by averaging the characteristic values of 6 or more identical batteries manufactured with the same sample.

### (d) Measurement of High-Rate Charge/Discharge Characteristics

Analysis of high-rate charge/discharge for the assembled lithium secondary battery was performed at 25 °C by a constant current-constant voltage (CCCV) method, identically to (c). The high-rate charge/discharge characteristics were represented as a capacity (mAh/g) measured by changing a current density during charging/discharging, increasing a constant supplied or discharged current density by cycle, and performing charge/discharge at the current density.

### Example 1

Corn starch and an isocyanate were mixed to manufacture a negative electrode active material for a secondary battery.

70 g of industrial corn starch, 25 g of MDI (50 wt % of polymeric diphenylmethane diisocyanate (MDI) and 50 wt % of 4,4′-MDI), and 5 g of tris(2-chloropropyl) phosphate (TCPP) were stirred for 30 minutes to prepare a precursor mixture. The precursor was heated to 600 °C in a nitrogen gas atmosphere without drying, and precarbonization was performed while the temperature was maintained at 600 °C for 1 hour to obtain a negative electrode active material precursor for a secondary battery with a carbonization yield of 38%. The obtained negative electrode active material precursor was finely ground into an average particle diameter of about 6 to 12 μm using a jet mill, and the maximum particle size did not exceed 50 μm. The finely ground negative electrode active material precursor underwent a carbonization process by placing the material in a crucible made of ceramic, heating the crucible to 1200 °C at a heating rate of 5 °C/min under a nitrogen gas atmosphere, and maintained at 1200 °C for 1 hour, thereby manufacturing a carbon material which may be used as a negative electrode active material for a lithium secondary battery. Hereinafter, the negative electrode active material for a secondary battery manufactured in Example 1 was measured according to the <Evaluation test items> described above, and the results are shown in the following Tables 1 to 3.

### Comparative Example 1

100 g of a polyol including 7 wt % of a hydroxyl group (AKP SSP-104) and 175 g of 4,4′-MDI were stirred at a speed of 4000 rpm for 10 seconds to prepare a cured polyurethane resin. The polyurethane resin was ground using a grinder so that the particle diameter was 0.1 to 2 mm, and the ground product was heated to 700 °C under a nitrogen gas atmosphere and maintained at 700 °C for 1 hour to perform precarbonization, thereby obtaining a negative electrode active material precursor for a lithium secondary battery with a carbonization yield of 38%. The obtained negative electrode active material precursor was finely ground into an average particle diameter of about 6 to 12 μm using a jet mill, and the maximum particle size did not exceed 50 μm. The finely ground negative electrode active material precursor underwent a carbonization process by placing the material in a crucible made of ceramic, heating the crucible to 1200 °C at a heating rate of 5 °C/min under a nitrogen gas atmosphere, and maintained at 1200 °C for 1 hour, thereby manufacturing a carbon material which may be used as a negative electrode active material for a lithium secondary battery. The results are shown in the following Tables 1 to 3.

### Comparative Example 2

The process was performed in the same manner as in Example 1, except that the isocyanate compound was not used. The results are shown in Table 1 and 3.

### Example 2

The process was performed in the same manner as in Example 1, except that 60 g of the corn starch was changed to 35 g of 4,4′-MDI. The results are shown in Table 1 and 3.

### Example 3

The process was performed in the same manner as in Example 1, except that 65 g of the corn starch was changed to 30 g of 4,4′-MDI. The results are shown in Table 1 and 3.

### Example 4

The process was performed in the same manner as in Example 1, except that 75 g of the corn starch was changed to 20 g of 4,4′-MDI. The results are shown in Table 1 and 3.

### Example 5

The process was performed in the same manner as in Example 1, except that 80 g of the corn starch was changed to 15 g of 4,4′-MDI. The results are shown in Table 1 and 3.

### Example 6

The process was performed in the same manner as in Example 1, except that the carbonization temperature was 1100 °C. The results are shown in Table 1 and 3.

### Example 7

The process was performed in the same manner as in Example 1, except that the corn starch was changed to potato starch. The results are shown in Table 1 and 3.

### Example 8

The process was performed in the same manner as in Example 1, except that TCPP as the phosphorus-based flame retardant was changed to toluene diisocyanate. The results are shown in Table 1 and 3.

### Example 9

The process was performed in the same manner as in Example 1, except that the phosphorus-based flame retardant was not added. The results are shown in Table 1 and 3.

TABLE 1

| | | First firing | | Second firing | | Total |
|---|---|---|---|---|---|---|
| Sample | | | Yield | | Yield | yield |
| name | Classification | conditions | (%) | conditions | (%) | (%) |
| Example 1 | 70 g of Corn starch, 25 g of MDI, | 600 °C | 38.6 | 1200 °C | 88.2 | 34.0 |
| | and 5 g of TCPP | | | | | |
| Comparative | 100 g of polyol (AKP SSP-104) and | 700 °C | 35.9 | 1200 °C | 87.4 | 31.4 |
| Example 1 | 175 g of 4,4′-MDI | | | | | |
| Comparative | No addition of MDI of Example 1 | 600 °C | 27.1 | 1200 °C | 87.1 | 24.8 |
| Example 2 | | | | | | |
| Example 2 | 60 g of Corn starch, 35 g of MDI, | 600 °C | 41.4 | 1200 °C | 86.7 | 36.0 |
| | and 5 g of TCPP | | | | | |
| Example 3 | 65 g of Corn starch, 30 g of MDI, | | 40.2 | | 87.7 | 35.2 |
| | and 5 g of TCPP | | | | | |
| Example 4 | 75 g of Corn starch, 20 g of MDI, | | 34.8 | | 89.7 | 31.2 |
| | and 5 g of TCPP | | | | | |
| Example 5 | 80 g of Corn starch, 15 g of MDI, | | 33.6 | | 90.6 | 30.5 |
| | and 5 g of TCPP | | | | | |
| Example 6 | Second firing temperature of Example 1 | | 39.0 | 1100 °C | 88.8 | 34.6 |
| | was changed to 1100 °C. | | | | | |
| Example 7 | Corn starch of Example 1 was changed | | 40.1 | 1200 °C | 86.4 | 34.6 |
| | to potato starch. | | | | | |
| Example 8 | Flame retardant of Example 1 was | | 29.7 | | 88.4 | 26.2 |
| | changed to toluene diisocyanate (TDI). | | | | | |
| Example 9 | No addition of flame retardant | | 29.4 | | 88.1 | 25.9 |
| | of Example 1. | | | | | |

TABLE 2

XRD

| | D002 | R value | Crystallite |
|---|---|---|---|
| | (Å) | (B/A) | size (Å) |
| Example 1 | 3.77 | 1.98 | 9.45 |
| Comparative Example 1 | 3.72 | 1.62 | 9.46 |

TABLE 3

| | | | Dis- | Specific |
|---|---|---|---|---|
| | | Charge | charge | surface |
| Sample | | capacity | capacity | area |
| name | Classification | (mAh/g) | (mAh/g) | (m²/g) |
| Example 1 | 70 g of Corn starch, | 412.6 | 327.8 | 2.5 |
| | 25 g of MDI, and | | | |
| | 5 g of TCPP | | | |
| Comparative | 100 g of polyol | 333.5 | 278.5 | 2.9 |
| Example 1 | (AKP SSP-104) | | | |
| | and 175 g of MDI | | | |
| Comparative | No addition of | 305.4 | 251.6 | 3.9 |
| Example 2 | MDI of Example 1 | | | |
| Example 2 | 60 g of Corn starch, | 416.1 | 343.7 | 2.6 |
| | 35 g of MDI, and | | | |
| | 5 g of TCPP | | | |
| Example 3 | 65 g of Corn starch, | 413.6 | 333.9 | 2.4 |
| | 30 g of MDI, and | | | |
| | 5 g of TCPP | | | |
| Example 4 | 75 g of Corn starch, | 398.9 | 302.2 | 2.4 |
| | 20 g of MDI, and | | | |
| | 5 g of TCPP | | | |
| Example 5 | 80 g of Corn starch, | 404.5 | 297.7 | 2.2 |
| | 15 g of MDI, and | | | |
| | 5 g of TCPP | | | |
| Example 6 | Second firing | 477.0 | 337.7 | 2.2 |
| | temperature of | | | |
| | Example 1 was | | | |
| | changed to 1100 °C. | | | |
| Example 7 | Corn starch of | 427.1 | 325.2 | 1.9 |
| | Example 1 was | | | |
| | changed to potato | | | |
| | starch. | | | |
| Example 8 | Flame retardant of | 371.9 | 297.4 | 2.7 |
| | Example 1 was | | | |
| | changed to toluene | | | |
| | diisocyanate (TDI). | | | |
| Example 9 | No addition of | 388.0 | 300.5 | 2.7 |
| | flame retardant of | | | |
| | Example 1 | | | |

As shown in Table 1, it was confirmed that as the weight ratio of the isocyanate was decreased, the carbonization yield was decreased.

In addition, in the case of the negative electrode active material manufactured according to the examples of the present disclosure, it was confirmed that the charge capacity and the discharge capacity were significantly increased as compared with the negative electrode active material using a resin-based raw material as in Comparative Example 1 of Table 3, and the discharge capacity tended to be decreased as the weight ratio of the isocyanate was decreased as in Examples 2, 3, 4, and 5.

In addition, in the case of the negative electrode active material manufactured according to the examples of the present disclosure, it was confirmed that the specific surface area was decreased as compared with the negative electrode active material using a resin-based raw material as in Comparative Example 1 of Table 3.

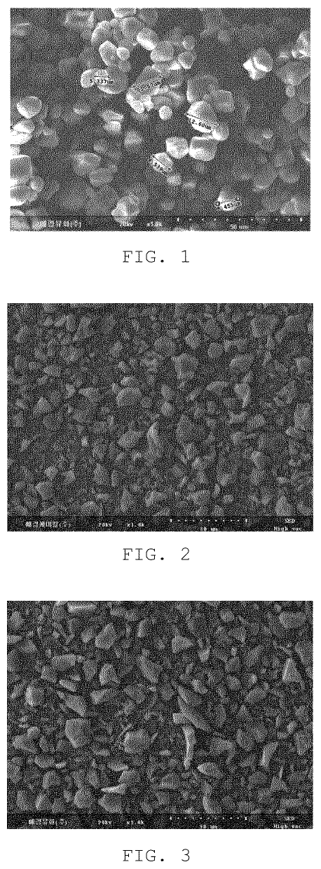

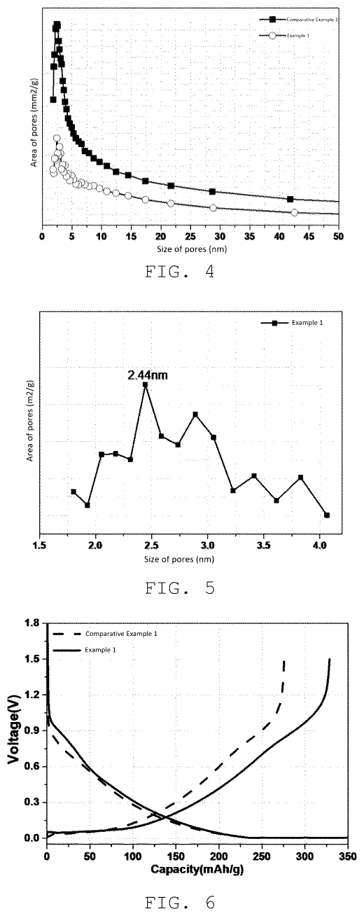

FIGS. 1 to 3 shows the scanning electron microscope photographs of the corn starch used in the present disclosure, the negative electrode active material manufactured according to Example 1, and the resin-based hard carbon manufactured according to the manufacturing method of Comparative Example 1. It was confirmed that the corn starch had spherical particles as shown in FIG. 1, but the negative electrode active material manufactured according to Example 1 of FIG. 2 had a non-uniform particle form which did not have a specific shape. It was confirmed that the negative electrode active material manufactured by the manufacturing method of the present disclosure had the same particle form as the resin-based negative electrode active material shown in FIG. 3.

In addition, it was found that the negative electrode active material manufactured according to Example 1 of the present disclosure did not have mesopores developed on the surface of carbon, as shown in FIG. 4, to have a low moisture content, had a decreased adsorption amount of moisture to have a decreased irreversible capacity, and had significantly improved electrochemical properties such as increased initial charge/discharge efficiency.

FIG. 7 shows a graph of evaluating room temperature discharge output characteristics of the negative electrode active material manufactured according to Example 1 of the present disclosure and the negative electrode active material manufactured according to Comparative Example 1. As a result of performing fast charging and discharging by gradually increasing current strength, it was confirmed that the discharge capacity retention rate showed the same level as that of a resin-based negative electrode active material.

Hereinabove, the preferred exemplary embodiment of the present disclosure was described, however, various modifications and equivalents may be used in the present disclosure, and it is apparent that the above exemplary embodiments may be properly modified and identically applied. Therefore, the above description does not limit the scope of the present disclosure which is defined by the claims which follow.

1. A negative electrode active material for a secondary battery comprising a carbide which is carbonized by heat treating a mixture including starch and an isocyanate under an inert gas atmosphere.

2. The negative electrode active material for a secondary battery of claim 1, wherein the mixture further includes a phosphorus-based flame retardant.

3. The negative electrode active material for a secondary battery of claim 1, wherein the starch is at least one selected from the group consisting of corn starch, rice starch, barley starch, wheat starch, cassava starch, potato starch, and sweet potato starch.

4. The negative electrode active material for a secondary battery of claim 1, wherein the negative electrode active material has an average diameter (D50) of carbide particles of 3 to 50 μm, a specific surface area of 1.9 to 2.7 m²/g, and an average pore size of 1.0 to 5 nm.

5. The negative electrode active material for a secondary battery of claim 1, wherein the negative electrode active material has an average layer plane spacing (d002) of a (002) plane by X-ray diffraction analysis of 3.7 to 4.0 Å, a crystallite diameter Lc(002) in the C-axis direction of 0.9 to 1.0 nm, and an R value of 1.7 to 2.

6. The negative electrode active material for a secondary battery of claim 1, wherein the starch has a spherical particle form having an average diameter (D50) of 5 to 10 μm and has an amorphous particle form after the heat treatment.

7. The negative electrode active material for a secondary battery of claim 1, wherein the isocyanate is included at 15 to 40 parts by weight with respect to 100 parts by weight of the mixture.

8. The negative electrode active material for a secondary battery of claim 1, wherein the isocyanate is at least one selected from the group consisting of hexamethylene diisocyanate (HDI), isophorone diisocyanate (IPDI), 4,4′-dicyclohexylmethane diisocyanate (H12MDI), polyethylene polyphenyl isocyanate, toluene diisocyanate (TDI), 2,2′-diphenylmethane diisocyanate (2,2′-MDI), 2,4′-diphenylmethane diisocyanate (2,4′-MDI), 4,4′-diphenylmethane diisocyanate (4,4′-MDI), polymeric diphenylmethane diisocyanate (polymeric MDI), orthotoluidine diisocyanate (TODI), naphthalene diisocyanate (NDI), xylene diisocyanate (XDI), lysin diisocyanate (LDI), and triphenylmethane triisocyanate (TPTI).

9. A method for manufacturing a negative electrode active material for a secondary battery, the method comprising: carbonizing by heat treating a mixture including starch and an isocyanate under an inert gas atmosphere.

10. The method for manufacturing a negative electrode active material for a secondary battery of claim 9, wherein the carbonizing includes:
precarbonizing by heat treating at a temperature of 600 to 1000 °C; and
carbonizing at a temperature of 1000 to 1400 °C.

11. The method for manufacturing a negative electrode active material for a secondary battery of claim 10, further comprising: fine grinding by grinding particles of the negative electrode active material for a secondary battery so that the particles have an average diameter (D50) of 3 to 50 μm.

12. The method for manufacturing a negative electrode active material for a secondary battery of claim 11, wherein the fine grinding is performed before the precarbonizing, after the precarbonizing, or after the carbonizing.

13. A secondary battery comprising the negative electrode active material for a secondary battery of claim 1.

14. A negative electrode active material for a secondary battery, which has an average particle diameter (D50) of 3 to 50 μm, a specific surface area of 1.9 to 2.7 m²/g, and an average pore size of 1.0 to 5 nm.

15. The negative electrode active material for a secondary battery of claim 14, wherein the negative electrode active material has an average layer plane spacing (d002) of a (002) plane by X-ray diffraction analysis of 3.7 to 4.0 Å, a crystallite diameter Lc(002) in the C-axis direction of 0.9 to 1.0 nm, and an R value of 1.7 to 2.
